(19) United States
(12) Patent Application Publication
(10) Pub. No.: US 2014/0330584 A1
(43) Pub. Date: Nov. 6, 2014

(54) PATIENT MEDICAL DATA ACCESS SOFTWARE

(71) Applicant: SIERRA NEVADA CORPORATION, SPARKS, NV (US)

(72) Inventors: Russell B. Pillers, Sparks, NV (US); Brian K. Streng, Sparks, NV (US); Rob Harker, Sparks, NV (US); Roger W. Andersen, Sparks, NV (US); Khanh Dac Le, Sparks, NV (US)

(73) Assignee: SIERRA NEVADA CORPORATION, SPARKS, NV (US)

(21) Appl. No.: 14/263,686

(22) Filed: Apr. 28, 2014

Related U.S. Application Data
(60) Provisional application No. 61/819,473, filed on May 3, 2013.

(51) Int. Cl. G06Q 50/24; G06Q 10/10

(52) U.S. Cl. CPC G06Q 50/24; G06Q 10/10
USPC 705/3

(57) ABSTRACT

A software application enables a user (such as for example a medical care provider) to acquire, enter, view, and store data related to medical care and/or transport of a patient. The software application enables one or more care providers to acquire and enter data in a timely manner beginning at the time medical care commences until a later time, such as until disposition of the patient at a medical care facility.

### REFERENCE TO PRIORITY DOCUMENT

This application claims the benefit of priority under 35 U.S.C. §119(e) of U.S. Provisional Patent Application Ser. Number 61/819,473 entitled “PATIENT MEDICAL DATA ACCESS SOFTWARE” filed May 3, 2013 under 37 C.F.R. §1.78(a). Priority of the filing date is hereby claimed and the full disclosure of the aforementioned patent application is incorporated herein by reference.

### BACKGROUND

This disclosure relates software, systems and methods for storing, accessing, and/or distributing patient medical data.

Conventional medical evacuation (“medevac”) systems often function in isolation as such systems typically lack any integrated architecture for electronic capture or access of patient information during transit of the patient. Current medevac systems also lack a communication architecture that permits transmission of patient status. As a result, there is a decreased ability to collect and distribute patient information.

Given the lack of access to patient data during transport situations, transport care personnel are typically on their own with respect to managing critically wounded patients during transit of the patient. Survival and recovery rates of patients can be directly attributed to the quality of care provided by transport care personnel with such care being largely dependent on the entire medical transport/care system's access to the patient's relevant medical data. Access to such medical data can be even more important in extreme situations, such as critical traumatic injuries related to accidents or the battlefield, natural disasters, acts of terrorism, etc.

### SUMMARY

In view of the foregoing, there is a need for improved systems, software and methods for collecting, storing, accessing, and/or distributing patient medical data particularly during transport of a patient. A software application is disclosed herein that satisfies this need.

The disclosed software application and system allows transport care personnel to rapidly acquire and view the medical data, in an optimal fashion, store the data electronically, and distribute the data to any entity that can help improve patient care, such as receiving medical facilities. This creates “Critical Care Situational Awareness” which enables quick and accurate hand-off of patients and efficient preparation of care on arrival at medical facilities. This software application thus responds to the current gap in capability by capturing and communicating patient care/condition information beginning at the point of injury until disposition to definitive care at a medical facility.

In one aspect, there is disclosed a computer implemented method of managing and accessing patient-related data, comprising: by a computer system comprising computer hardware: receiving a data input from a care provider, the data input comprising a verbal or textual input related to a first patient; automatically associating the data input with a patient identifier for the first patient and storing the data input in a database associated with the first patient; assembling and displaying a user interface on the computer system, the user interface configured to display data related to the first patient; and transmitting the data related to the first patient over a computer network such that both a local user and a remote user may access and manipulate the data related to the first patient.

More details of the devices, systems and methods are set forth in the accompanying drawings and the description below. Other features and advantages will be apparent from the description and drawings.

### BRIEF DESCRIPTION OF THE DRAWINGS

These and other aspects will now be described in detail with reference to the following drawings. Generally speaking the figures are not to scale in absolute terms or comparatively but are intended to be illustrative. Also, relative placement of features and elements may be modified for the purpose of illustrative clarity.

FIG. 1 shows an exemplary architecture of a patient medical data access software system.

FIGS. 2A-2C show an exemplary data entry and access screen shots for a graphical user interface of the software system.

FIG. 3 shows an exemplary method of the software system.

### DETAILED DESCRIPTION

Disclosed is a software application that enables a user (such as for example a medical care provider) to acquire, enter, view, and store data related to medical care and/or transport of a patient. The software application enables one or more care providers to acquire and enter data in a timely manner beginning at the time medical care commences until a later time, such as until disposition of the patient at a medical care facility. In this regard, a graphical user interface (GUI) is associated with the software application, wherein the GUI provides an intuitive, practical and efficient means for the care provider(s) to enter and observe data associated with the patient. In addition, the software application communicates with one or more data distribution devices that distribute the data over a computer network for viewing and access by a remote user.

Upon entry of patient data, the software application creates or modifies an associated patient data element, which may be any piece of information that is relevant to patient care and/or treatment. The patient data element may relate to or indicate data associated with the patient or the patient's environment. This may include, but is not limited to, the patient's weight, height, age, body temperature, location of the patient, time stamp, date, vital signs, injury type, etc. The data element is associated with the patient throughout transport of the patient thereby permitting easy access and viewing of the data by both local and remote care providers.

The software application is configured to implement the transport or distribution of a patient's data elements over a communication network such that the patient data may be accessed and/or modified by a second care provider using the software application itself or a remote instance of the software application. Transport care personnel and staff at a medical facility can thus concurrently access a patient's vital statistics and current status. This concurrent access, combined with the features which allow the local and remote care providers to collaborate via text, voice or video chat applications, provide the patient with the best possible treatment at the point of injury and while en route to a medical facility. In an embodiment, the software application communicates with a medical data router device, such as the type of data router described in co-pending U.S. patent application Ser. No. 14/166,272 entitled “PATIENT MEDICAL DATA ACCESS SYSTEM”, which was filed on Jan. 28, 2014 and is incorporated by reference in its entirety.

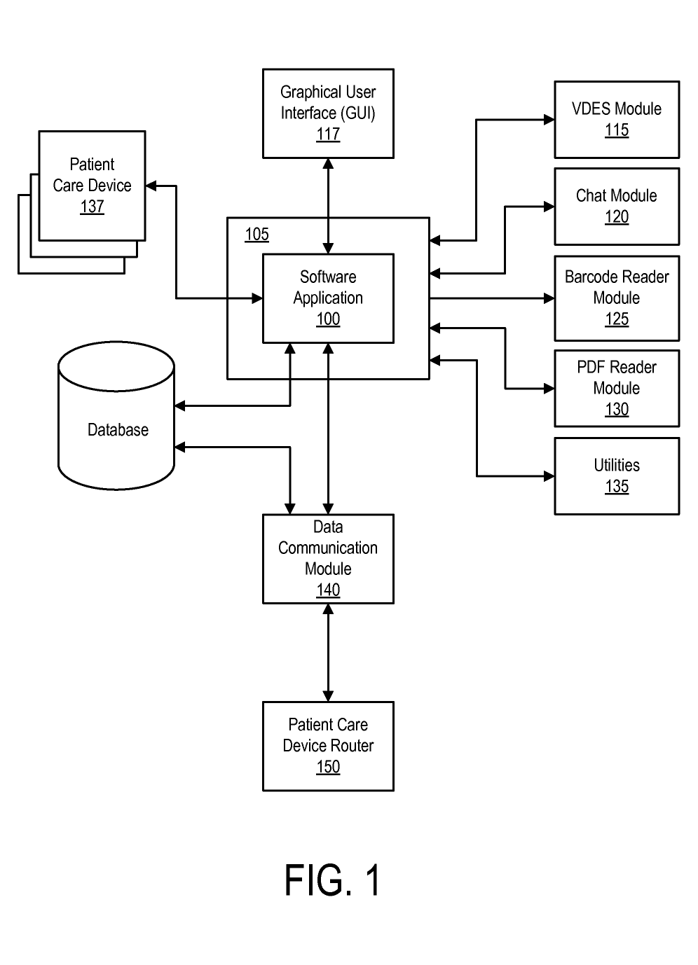

FIG. 1 shows a schematic, block diagram of an exemplary architecture of the software application and associated components. The software application 100 may reside on a computer platform 105. The software application is configured to cause the computer platform 105 to display a GUI on a display screen, as described more fully below. The computer platform may vary and may be, but is not limited to, a laptop computer, tablet, cellular telephone, desktop computer, or other user device. In an embodiment, the computer platform 105 is a mobile device.

One or more hardware devices or software modules may be communicatively coupled to or included in the software application 100 and computer platform 105. These modules may include, for example, a Voice Data Entry System (VDES) module 115 that automatically converts audio signals acquired by a voice microphone into commands or free text. In this regard, the computer platform may include or be coupled to a microphone. The converted speech elements are stored within the associated patient data in the database. In transit, the care provider may communicate via text chat or voice data communication to gain specialist support such as from a remote location. Using the VDES, the care provider may verbally interact with the software application to input patient data into the system. For example, the care provider may verbally provide data such as patient name, date, blood pressure, injury, etc. for receipt by the software application. A text chat module 120 provides the ability for real time textual communication between devices.

A barcode reader module 125 is configured to enable reading of electronic barcodes and may be used, for example, to rapidly identify a patient. In this regard, the software application may create a new database entry for the patient or recall an already existing database entry in response to data obtained from the barcode. In a military environment, for example, soldiers may be wearing identification tags with an imprinted barcode. Individuals without an identification tag may have a barcode applied to their person by the care provider to facilitate tracking. A PDF reader module 130 displays PDF documents, which may include various information such as drug formularies, references and protocols. Other utilities, such as a calculator module 135 can also be utilized.

The software application is communicatively connected to one or more patient care medical devices 137, as well as one or more connected communication modules 140 or communication devices such as a line of sight or satellite radio, a connected power source, and a computer controlled device used by transport care personnel. At any time within the software process, once a patient is received and connected to a medical device, the software application 100 automatically creates a new database entry containing the patient vitals or accesses an existing entry, as described below. The connected medical devices may include, but are not limited to, any number and combination of devices such as: EKG, blood pressure monitor, pulse monitor, ventilator, defibrillator, IV pump, EEG, oxygen sensor, or other physiological devices.

With reference still to FIG. 1, the software application is configured to store all received data into a local or remote database 150 in accordance with configuration specifications. As mentioned, the software application communicates with a patient care device router 155 that permits transport care personnel to communicate via text, voice or video chat with staff at a medical treatment facility or other remote location. The software application transmits data from the database via the connected patient care device router 155 to an external network in accordance with configured specifications. The data may be transmitted to server or set of servers (referred to as a “home base”). The home base then may distribute the data to one or more entities or locations, such as a medical facility, a dispatch center, command control center, etc. The data may also be sent to or otherwise stored in a pre-existing electronic health record (EHR) database. In an embodiment, the data is collected and stored locally. Pursuant to a store and forward process, the software causes the data to be stored locally and then distributed to the home base if a communication link to the home base is available. If no communication link is available, then the data is stored locally until a link becomes available, at which time the data is sent to the home base. As mentioned, an exemplary patient care device router is described in co-pending U.S. patent application Ser. No. 14/166,272 entitled “PATIENT MEDICAL DATA ACCESS SYSTEM”, which was filed on Jan. 28, 2014 and is incorporated by reference in its entirety.

As discussed, the software application is configured to cause a GUI to be displayed on a display screen of the computer platform 105. The GUI provides an intuitive, practical and efficient means for the care provider(s) to enter and observe data associated with the patient. The data may be entered in a text format (such as via a keyboard or touchscreen) and/or may be entered verbally in conjunction with the VDES module 115.

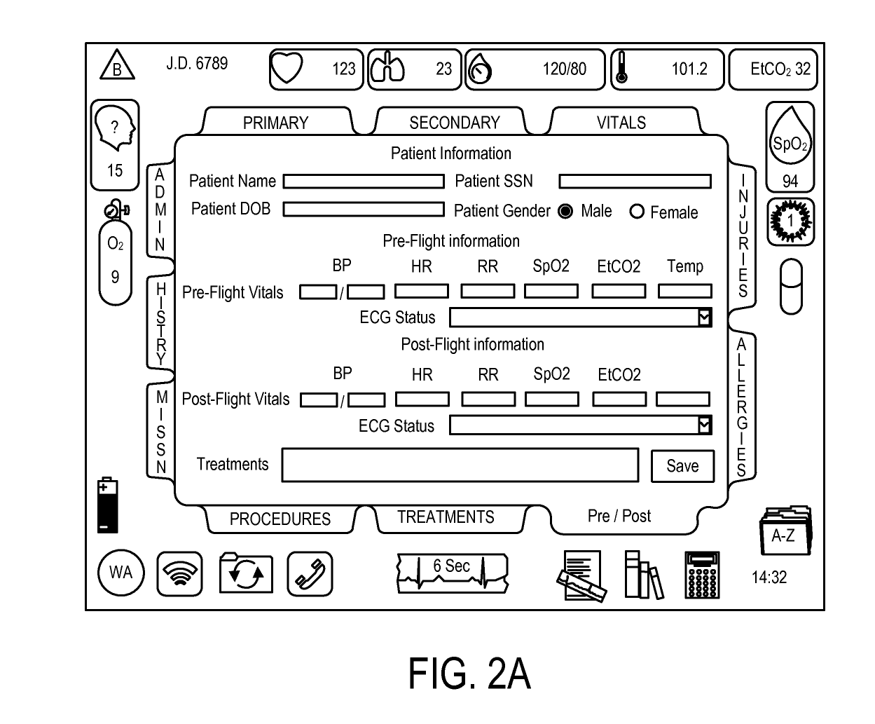

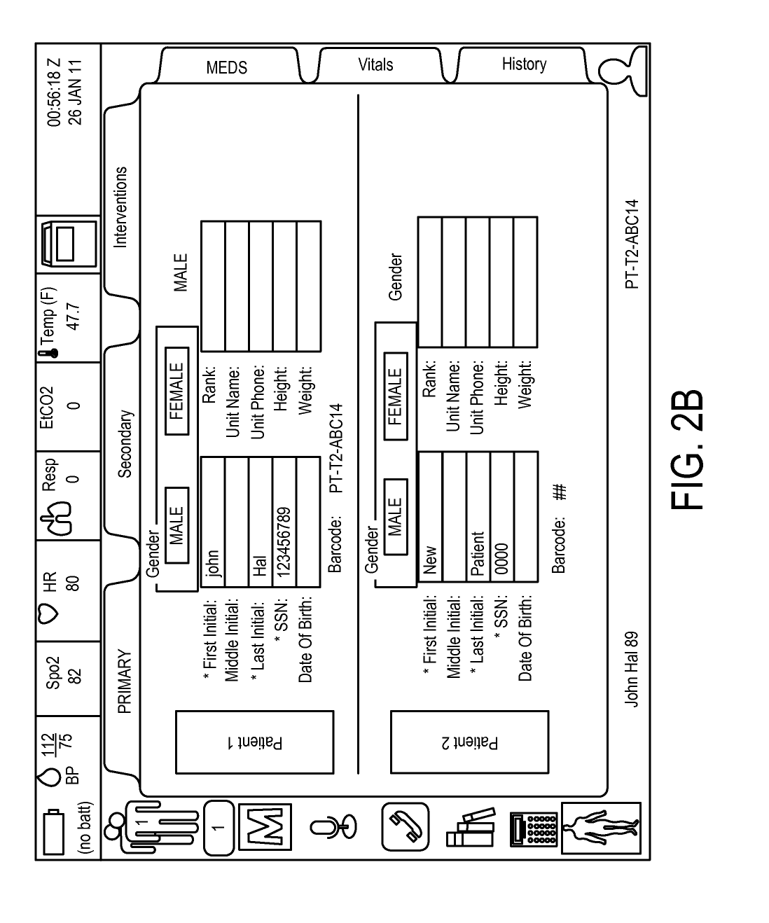

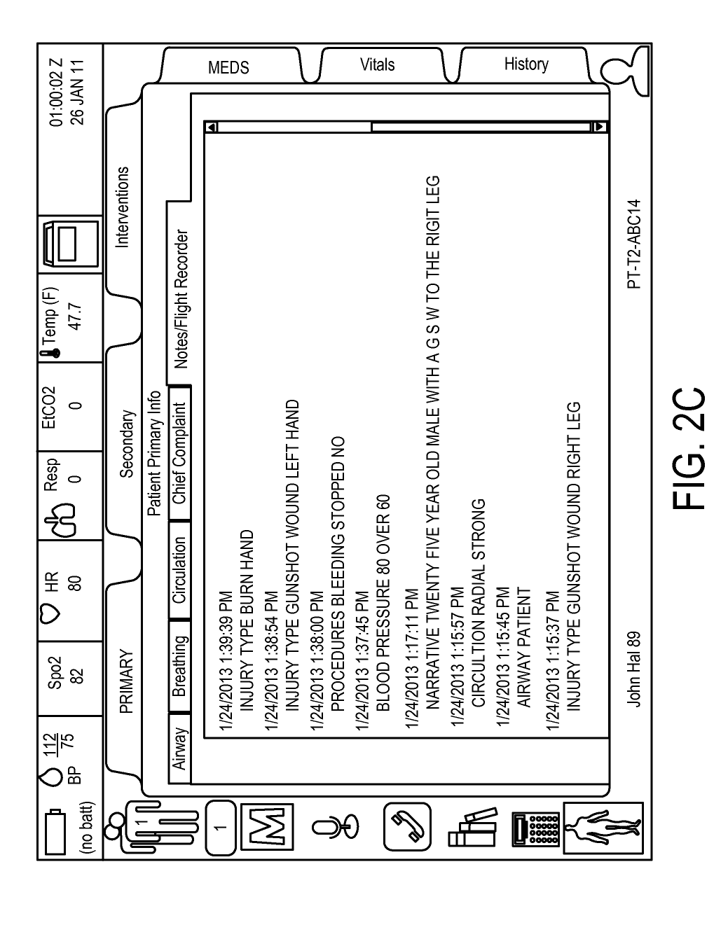

FIG. 2 shows an exemplary data entry and access screen shot for a GUI. It should be appreciated that the GUI of FIG. 2 is an example and that variations are within the scope of this disclosure. With reference to FIG. 2, the GUI includes data fields for entry and display of data. The GUI includes fields for a variety of data types, including patient name, date of birth, social security number, and vital information. The GUI may include fields for any of a variety of medical or treatment related information including heart rate, blood pressure, respiratory pressure, body temperature, vitals, treatment methodology, medications delivered and other information.

With reference still to FIG. 2A, the GUI may include one or more tabs that may be selected to access one or more other pages. The tabs may include a descriptive label that describes the corresponding page such as, for example, “Primary”, “Secondary”, “Vitals”, etc. Other tabs may include an “Injuries” tab for display of injury-related information, an “Allergies” tab, an “Admin” tab, a “History” tab, and a “Mission” tab. Any of a variety of tabs may be used to access and display information. FIGS. 2B-2C show examples of additional GUIs.

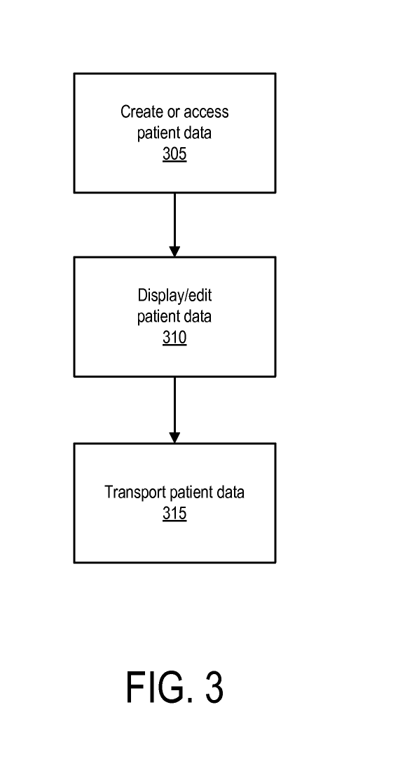

FIG. 3 shows a flowchart that represents an exemplary method of operation for the software application. In a first step 305, the software application creates or accesses data associated with a patient. This may occur as a result of any of a variety of actions, such as care provider initiating the application or the care provider connecting or activating a medical device coupled to the software application. The software application is configured on power-up and/or during operation to receive real-time data from connected medical device(s). The software application sends a signal and interrogates each connected medical device. The software application determines the appropriate communication protocol to use for each medical device in a “plug and play” manner. The software application automatically processes the data from the various medical devices and combines that data with additional data received from the connected patient care device router.

At any time within the process, once a patient is received and connected to one or more of the medical devices, the software application may automatically create a new database entry containing the patient medical data, such as data associated with patient vitals. As mentioned, patients may be wearing identification tags with an imprinted barcode. The Barcode Reader Module 125 may query a laser scanner to rapidly identify the patient, to which the software application will either create a new database entry for the patient or recall an already existing database entry.

In a next step 310, the software application interacts with the care provider to display the data for viewing and/or editing by the care provider. In an embodiment, the software application displays the data using the aforementioned GUI. The software application also utilizes one or more of the software modules to gain or edit data. For example, using the Voice Data Entry System (VDES), the care provider may input patient physiological data and treatments provided. The VDES module is an accessory to manual entry of data using a device such as a keyboard and mouse. This module converts audio signals acquired by a voice microphone into commands or free text. This converted voice data is stored with the associated patient data in the database.

With respect to the GUI, the amount of patient data may be extensive such that not all data may be visible on a single video screen at any given time. Some patient data may be visible at all times and some patient data may be accessed through interaction with the GUI by a transport care provider. In an embodiment, the type of patient data visible at all times includes, but is not limited to: the patient's name and/or some other identifier, heart rate, respiration rate, blood pressure, temperature, oxygen saturation, carbon dioxide levels, allergies, and other physiological statistics in any combination. Other data that may be visible at all times may include, but is not limited to: current time, power status of the computer device, network communication status, network signal strength, current location, or other similar data in any combination.

At some point during the process, which may be continuously or at regular intervals, the software application causes the data to be transported over a communication network for access at a remote location, such as a care facility. In this regard, the software application is coupled to the patient care device router (FIG. 1), which initiates communications with a data network. Upon the software application and the router initiating communications, patient data is transmitted over the computer network through the data communication module. In transit, the care provider has the capability to gain support by text, voice or video communication to gain specialist support, which now has full access to the patient's status. As mentioned, the data may be transmitted to a home base server or collection of servers. In an embodiment, the data is collected and stored locally whether or not a communication link to the home base is available. Pursuant to a store and forward process, the software causes the data to be stored locally and then distributed to the home base if a communication link to the home base is available. If no communication link is available, then the data is stored locally until a link becomes available, at which time the data is sent to the home base.

### Data Throttling

The software is configured to adjust the flow of data to the home base so as to maximize or otherwise increase the likelihood of successful transmission of the data. This is done by attempting to match sent data volume to available communication bandwidth. In this regard, the software is configured to perform one or more operations for adjusting the flow of data.

The software stores the patient data in a data structure wherein the patient data is organized into one or more patient data elements. Each patient data element is associated with a ‘priority’ wherein the priority indicates a relative value or importance of the patient data element. The priority may vary and may be associated with a situational awareness focused on providing the best care possible.

The priority value may range from a value associated with a highest (or most important priority) to a value associated with a lowest (or least important) priority. For example, the priority may range from one (1) for a “high” to five (5) for a “low” with intermediate values 2, 3, and 4 ranging between the two. This is just an example and it should be appreciated that the range of priority values may vary.

A patient data element may be any piece of information that is relevant to patient care and/or treatment. For example, a patient data element may relate to or indicate patient's blood pressure reading or any other data associated with the patient or the patient's environment. Other examples include the patient's weight, height, age, body temperature, location of the patient, etc.

In the example of the patient's blood pressure, the patient's blood pressure may be assigned, for example, a priority of one (1) while details about the environment or location may be given a lower priority. The actual patient data elements and the corresponding priority value may be assigned in a variety of manners. An expert in the care of critical patients may define a default set of priorities while a care provider or other entity at the point of care location may be able to edit the priority value of each patient data element. Each patient data element may also have an associated timestamp indicating when that piece of information was captured.

The transmission of data may operate pursuant to a predetermined method. An exemplary method of transmitting data pursuant to a data-throttling scheme is now described. In a first step, a data transmission cycle begins by starting a timer. The timer defines an amount of time that is allocated for transmitting a patient data element. The value of the timer may vary. It may have a default value or a user may program the value of the timer at the point of care location.

In a next step, the software attempts to transmit any unsent patient data elements, with precedence going to the patient data element with the highest priority value. That is, the unsent patient data element with the highest priority is the one that is sent first. If the timer expires prior to all of the highest priority data elements being sent, then the method either terminates or the timer is restarted. The software continues to attempt to send the highest priority data elements as long as the timer is not expired. Once the patient data elements with the highest priority are successfully transmitted, and time remains in the cycle, transmission of the next lower priority data begins. When the timer expires, the method returns to the initial step wherein the timer is restarted and the software attempts to send the patient data element with the highest priority. This process continues until the device has successfully transmitted all patient data elements.

Other factors may be taken into account, such as the time stamp of the patient data element. This may ensure that the data being sent to the home base contains the most recent, most valuable information regarding the patient's condition and care. Specifically, during an individual time cycle of transmission, the data elements of a particular type, e.g. blood pressure, could be sent in order of those with the most recent time stamp first, then proceeding to older entries. The time length of the cycles will be adjustable to allow for fine-tuning.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a device having a display device, such as for example a liquid crystal display (LCD) monitor for displaying information to the user and a keyboard and an input device, such as for example a mouse or a trackball, by which the user may provide input to the device. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) when depicted in the accompanying figures and/or described herein do not necessarily require the particular order shown, or sequential order, to achieve desirable results. Other implementations may be within the scope of the following claims.

1. A computer implemented method of managing and accessing patient-related data, comprising:
by a computer system comprising computer hardware:
receiving a data input from a care provider, the data input comprising a verbal or textual input related to a first patient;
automatically associating the data input with a patient identifier for the first patient and storing the data input in a database associated with the first patient;
assembling and displaying a user interface on the computer system, the user interface configured to display data related to the first patient;
transmitting the data related to the first patient over a computer network such that both a local user and a remote user may access and manipulate the data related to the first patient.

2. A method as in claim 1, further comprising receiving an indication that a medical device is connected to the computer hardware and automatically querying the medical device for information related to the first patient.

3. A method as in claim 2, further comprising receiving data from the medical device and storing the medical device data in the database associated with the first patient.

4. A method as in claim 2, further comprising automatically determining a proper communication protocol for communicating with the medical device.

5. A method as in claim 1, further comprising receiving data via the user interface and storing the data input in the database.

6. A method as in claim 1, further comprising receiving information regarding an identity of the patient from a barcode scanner connected to the computer.

7. A method as in claim 1, wherein the data related to the first patient is transmitted automatically at regular time intervals.

8. A method as in claim 1, wherein the data related to the first patient is transmitted automatically upon a change in data related to the first patient.

9. A method as in claim 1, further comprising translating the verbal or textual input into a recognizable format.

10. A method as in claim 1, wherein the data input relates to at least one of a patient medical condition, a patient name, and a description of a patient.

11. A method as in claim 1, further comprising:
receiving a data input from a care provider, the data input comprising a verbal or textual input related to a second patient;
associating the data input with an identifier for the second patient and storing the data input in a database.

12. A method as in claim 1, further comprising:
locally storing the data;
determining whether a communication link is available to a remote location; and
transmitting the data to the remote location if a communication link is available.

13. A method as in claim 1, further comprising:
(a) identifying data to be transmitted;
(b) assign a priority to the data to be transmitted;
(c) attempting to transfer data with the highest priority;
(d) ceasing the attempt to transfer upon passage of a predetermined period of time.
